(19) United States
(12) Patent Application Publication
(10) Pub. No.: US 2006/0279882 A1
(43) Pub. Date: Dec. 14, 2006

(54) MAGNETIC DETECTING ELEMENT HAVING RIE-RESISTANT FILM AND METHOD OF MANUFACTURING THE SAME

(76) Inventors: Kenji Honda, Niigata-ken (JP); Naohiro Ishibashi, Niigata-ken (JP); Yasuo Hayakawa, Niigata-ken (JP); Yoshihiro Nishiyama, Niigata-ken (JP); Daigo Aoki, Niigata-ken (JP); Toshihiro Kobayashi, Niigata-ken (JP)

Correspondence Address: BRINKS HOFER GILSON & LIONE, P.O. BOX 10395, CHICAGO, IL, 60610, US

(21) Appl. No.: 11/421,732

(22) Filed: Jun. 1, 2006

(30) Foreign Application Priority Data
Jun. 14, 2005 (JP) 2005-173420

(51) Int. Cl. G11B 5/127; G11B 5/33

(52) U.S. Cl. 360/324.12

(57) ABSTRACT

There is provided a magnetic detecting element and a method of manufacturing the same. An intermediate layer and a corrosion preventing layer are laminated on a free magnetic layer. The corrosion preventing layer prevents the free magnetic layer from corroding due to reactive ion etching. Therefore, a laminator can be correspondingly formed in a predetermined shape, and the free magnetic layer can be prevented from corroding. As a result, it is possible to manufacture a magnetic detecting element having excellent reproduction output.

### BACKGROUND

1. Field

A magnetic detecting element that is capable of forming a laminator in a predetermined shape and preventing a free magnetic layer from corroding. The laminator has a fixed magnetic layer and a non-magnetic material layer. The free magnetic layer is formed in a predetermined shape using a mask layer for forming the laminator. Also provided is a method of manufacturing the magnetic detecting element.

2. Related Art

In JP-A-2004-14705 and JP-A-2004-14610, a structure of a Current In Plane (CIP) type magnetic detecting element is disclosed. The CIP type refers to a structure in which current flows in a direction parallel to a wall surface of each of layers of a laminator, that is, a laminating portion having a four-layered structure which has a ferromagnetic layer, a fixed magnetic layer, a non-magnetic material layer, and a free layer, that forms the magnetic detecting element.

There is also a magnetic detecting element that has a structure in which current flows in a direction perpendicular to the wall surface. This magnetic detecting element is referred to as a Current Perpendicular to Plane (CPP) type magnetoresistance effect element.

Generally, when forming the laminator in a predetermined shape, for example, as disclosed in FIG. 3 in JP-A-2004-14705, using a lift-off resist layer (a layer shown by reference numeral R1 in FIG. 3 in JP-A-2004-14705), a portion of the laminator, which is not covered with the resist layer, is removed by an ion milling method. In addition, in a state in which the resist layer remains as it is, as disclosed in FIG. 4 in JP-A-2004-14705, a hard bias layer or the like is formed on both sides of the laminator, and the resist layer is lifted off.

However, according to the related art, due to a shadow effect of the resist layer, it may be difficult for the hard bias layer to be attached to the peripheral portions at both sides of the laminator, which results in an extreme decrease in the thickness of the hard bias layer in the peripheral portions at both side of the laminator. As a result, it is not possible to apply a bias electric field having a predetermined strength to the free magnetic layer.

Accordingly, instead of the method that uses the liftoff resist layer, another method has been suggested in which a laminator is formed in a predetermined shape by using a metallic mask layer.

FIG. 7 is a diagram illustrating one process of a method of forming the laminator in a predetermined shape by using the metallic mask layer. Further, FIG. 7 is a partial cross-sectional view illustrating a state in which the laminator during a manufacturing process is cut from a direction parallel to a recording medium facing surface (a surface parallel to an X-Z plane in FIG. 7).

In FIG. 7, reference numeral 1 indicates a substrate. A laminator 6 is formed on the substrate 1. The laminator 6 has a structure in which an antiferromagnetic layer 2, a fixed magnetic layer 3, a non-magnetic material layer 4, and a free magnetic layer 5 are sequentially laminated from the bottom. The respective layers, which form the laminator 6, are formed on an entire surface of a top surface of the substrate 1 by means of a sputtering method.

As shown in FIG. 7, a metallic mask layer 7 is formed on the laminator 6. The metallic mask layer 7 is formed of a material containing Ta. First, the metallic mask layer 7 is formed on an entire surface of a top surface of the laminator 6 by means of a sputtering method. Then, a Cr mask layer 8 is formed on the metallic mask layer 7 such that the metallic mask layer 7 becomes a shape shown in FIG. 7.

In the meantime, when portions of the laminator 6, which is not covered with the metallic mask layer 7, are cut by an ion milling method, the metallic mask layer 7 should not be cut in the same manner as the laminator 6. If the metallic mask layer 7 is cut in the same manner as the laminator 6, it is not possible for the metallic mask layer 7 to perform an original function as a mask. Therefore, as a forming material of the metallic mask layer 7, a material, which is difficult to be cut by an ion milling method, is selected. The above-mentioned Ta corresponds to an example of the material which is difficult to be cut by an ion milling method. In order to allow a cross section of the metallic mask layer 7 to have a substantially trapezoidal shape as shown in FIG. 7, it is essential to use a reactive ion etching (RIE) method for the Ta to be cut, such that it is difficult for the free magnetic layer 5 or the Cr mask layer 8 to be cut.

As shown in FIG. 7, a Cr mask layer 8 is formed on the metallic mask 7. At this time, when cutting the Ta layer shown by a dotted line 7a of FIG. 7 by means of the reactive ion etching method, the Cr mask layer 8 properly remains on the metallic mask layer 7.

If the Ta layer shown by the dotted line 7a is cut by means of the reactive ion etching method, a top surface 5a of the free magnetic layer 5 is exposed to the outside. Since it is difficult for the free magnetic layer 5 to be cut by the reactive ion etching method, the free magnetic layer 5 becomes a stopper layer of the reactive ion etching. When the top surface 5a of the free magnetic layer 5 is exposed to the outside, the reactive ion etching is finished.

However, it is likely for fluoride to be introduced on the stop surface 5a of the free magnetic layer 5, due to a mixed gas between C₃F₈ and Ar, a CF₄ gas, or the like, which are used at the time of the reactive ion matching. As a result, the free magnetic layer 5 may corrode.

FIG. 8 is an enlarged cross-sectional view illustrating a portion of the cross-sectional view shown in FIG. 7. As shown in FIG. 8, a fluoride deposition layer 9 is formed on the top surface 5a of the free magnetic layer 5. The fluoride deposition layer 9 is first formed on the top surfaces 5a at both side ends 5b that are not covered with the metallic mask layer 7 which is directly affected by the reactive ion etching. However, with the passage of time, the fluoride deposition layer 9 gradually expands to the top surface 5a of a central portion 5c below the metallic mask layer 7. The fluoride deposition layer 9, which is formed on the top surfaces 5a at both side ends 5b, is finally removed by the ion milling, but the fluoride deposition layer 9, which is formed on the top surface 5a of the central portion 5c, remains as it is.

In addition, the fluoride deposition layer 9, which is formed on the top surfaces 5a at both side ends 5b, becomes a mask at the time of an ion milling process. As a result, it is not possible to properly remove both side ends 5b by means of the ion milling process, or time required at the time of the ion milling process becomes increased, as compared with a regular amount of required time.

In addition, as shown in FIG. 7, in a state in which the metallic mask layer 7 remains on the free magnetic layer 5, a CIP magnetic detecting element is formed. In this case, since the current is divided into portions of the metallic mask layer 7, reproduction output is extremely lowered. Therefore, in the CIP-type magnetic detecting element, it is preferable that the metallic mask layer 7 be finally removed. However, in this case, the metallic mask layer 7 needs to be removed by the reactive ion etching, as described above. At this time, the top surface 5a of the free magnetic layer 5 is subjected to the reactive ion etching process, which results in corrosion of the free magnetic layer 5. In the CPP-type magnetic detecting element, the metallic mask layer 7 does not need to be removed, however, the free magnetic layer 5 below the metallic mask layer 7 becomes deformed due to the corrosion. Therefore, it is not possible to properly form not only the CIP-type magnetic detecting element but also a magnetic detecting element having an excellent reproduction characteristic.

### SUMMARY OF THE INVENTION

Provided is a magnetic detecting element which is capable of properly forming a laminator in a predetermined shape and preventing a free magnetic layer from corroding. The laminator has a fixed magnetic layer and, a non-magnetic material layer. The free magnetic layer is formed in a predetermined shape by using a mask layer for forming the laminator. Also provided is a method of manufacturing the magnetic detecting element.

The magnetic detecting element includes at least a fixed magnetic layer, a non-magnetic material layer, and a free magnetic layer which are laminated on a substrate in this order from the bottom, and a corrosion preventing layer against reactive ion etching which is directly or indirectly formed on the free magnetic layer.

The corrosion preventing layer against the reactive ion etching is directly or indirectly formed on the free magnetic layer. Therefore, the free magnetic layer can be properly prevented from corroding due to the reactive ion etching, which results in manufacturing a magnetic detecting element having an excellent reproduction characteristic.

Preferably, the corrosion preventing layer is formed of at least one element selected from the group consisting of Cr, Pt, Ir, Ru, Rh, Pd, and Ag. The corrosion preventing layer, which is formed of the above-mentioned element, can properly protect the free magnetic layer from the reactive ion etching.

Preferably, an intermediate layer is formed between the free magnetic layer and the corrosion preventing layer so as to suppress deterioration of a magnetic characteristic of the free magnetic layer, as compared with a case in which the corrosion preventing layer is formed directly on the free magnetic layer. Preferably, the intermediate layer is formed of at least one element selected from the group consisting of Ta, Ru, Cu, W, and Rh. Therefore, the magnetic characteristic of the free magnetic layer can be prevented from being deteriorated.

Preferably, the magnetic detecting element is a tunnel-type magnetic detecting element in which the non-magnetic material layer is formed of an insulating barrier layer. Therefore, even though the corrosion preventing layer or the intermediate layer is formed on the free magnetic layer, it is possible to properly improve the reproduction output.

Also provided is a method including the steps of: (a) laminating on a substrate at least a fixed magnetic layer, a non-magnetic material layer, and a free magnetic layer in this order from the bottom while forming a corrosion preventing layer against reactive ion etching directly or indirectly on the free magnetic layer; (b) forming on the corrosion preventing layer the laminator forming mask layer having a predetermined shape by means of the reactive ion etching, the reactive ion etching being completed around the laminator forming mask layer when a surface of the corrosion preventing layer is exposed to the outside; and (c) removing portions of the fixed magnetic layer, the non-magnetic material layer, the free magnetic layer, and the corrosion preventing layer, which are not covered with the laminator forming mask layer. Further, the corrosion preventing layer is formed of a material of which the etching speed of the reactive ion etching is slower than the etching speed of the reactive ion etching in a material of a laminator forming mask layer formed in the step of (b)

During the step of (a), after the corrosion preventing layer is directly or indirectly formed on the free magnetic layer, a metallic mask layer is formed on the corrosion preventing layer by means of the reactive ion etching. In this way, the free magnetic layer is covered with the corrosion preventing layer. Therefore, different from the related art, the free magnetic layer is not affected by the reactive ion etching, which results in preventing the free magnetic layer from corroding. As described above, the etching speed of the reactive ion etching in the corrosion preventing layer is slower than the etching speed of the reactive ion etching in the laminator forming mask layer. Accordingly, during the step of (b), in a state in which all of the corrosion preventing layer is not cut and at least a portion of the corrosion preventing layer remains, the reactive ion etching can be properly completed, and thus it is possible to properly protect the free magnetic layer from the reactive ion etching.

Preferably, the corrosion preventing layer is formed of at least one element selected from the group consisting of Cr, Pt, Ir, Ru, Rh, Pd, and Ag. The corrosion preventing layer, which is formed of the above-mentioned element, can properly protect the free magnetic layer from the reactive ion etching.

Preferably, the laminator forming mask layer is formed of at least one element selected from the group consisting of Ta, Mo, W, and Ti. Therefore, the laminator forming mask layer can be correspondingly formed in a predetermined shape by means of the reactive ion etching.

Preferably, during the step of (a), an intermediate layer is formed between the free magnetic layer and the corrosion preventing layer so as to suppress deterioration of a magnetic characteristic of the free magnetic layer, as compared with a case in which the corrosion preventing layer is directly formed on the free magnetic layer. Preferably, the intermediate layer is formed of at least one element selected from the group consisting of Ta, Ru, Cu, W, and Rh. Therefore, the magnetic characteristic of the free magnetic layer can be suppressed from being deteriorated.

Preferably, the method of manufacturing a magnetic detecting element further includes a step of: (d) forming bias layers at both sides of the laminator in a track width direction from the fixed magnetic layer to the laminator forming mask layer, which remains on the substrate, after the step of (c), the bias layer applying a bias magnetic field to the free magnetic layer.

The bias layer is not formed by using a liftoff resist layer as in the related art. Therefore, the bias layer can be formed with the large thickness, and a sufficient bias magnetic field can be supplied from the free magnetic layer to the bias layer.

Preferably, the method of manufacturing a magnetic detecting element further includes the steps of: after the step of (d), (e) forming a stopper layer on the bias layer; and (f) completing a process for removing unnecessary layers formed on a top surface of the laminator, when at least a portion of the stopper layer is removed.

Therefore, an amount to be removed can be properly controlled. In particular, the laminator or the bias layer can be properly prevented from being excessively removed.

### DRAWINGS

FIG. 1 is a partial cross-sectional view illustrating a state in which a structure of a tunnel-type magnetic detecting element according to an embodiment of the invention is cut from a direction parallel to a recording medium facing surface;

FIG. 2 is a partial cross-sectional view illustrating a state in which a tunnel-type magnetic detecting element during a manufacturing process is cut from a direction parallel to a recording medium facing surface;

FIG. 3 is a diagram illustrating one process subsequent to a process illustrated in FIG. 2 (a partial cross-sectional view);

FIG. 4 is a diagram illustrating one process subsequent to a process illustrated in FIG. 3 (a partial cross-sectional view);

FIG. 5 is a diagram illustrating one process subsequent to a process illustrated in FIG. 4 (a partial cross-sectional view);

FIG. 6 is a diagram illustrating one process subsequent to a process illustrated in FIG. 5 (a partial cross-sectional view);

FIG. 7 is a partial cross-sectional view illustrating a state in which a tunnel-type magnetoresistance effect element during a conventional manufacturing process is cut from a direction parallel to a recording medium facing surface; and

FIG. 8 is a partially enlarged cross-sectional view illustrating a portion of FIG. 7.

### DESCRIPTION

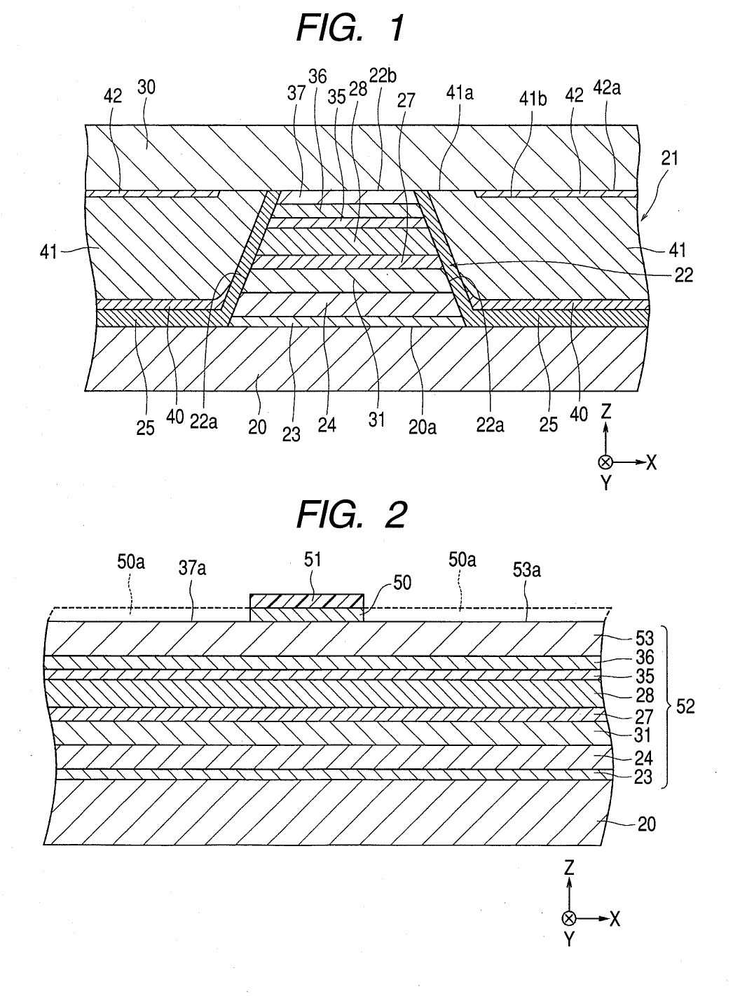

FIG. 1 is a partial cross-sectional view illustrating a state in which a structure of a tunnel-type magnetic detecting element is cut from a direction parallel to a recording medium facing surface.

The tunnel-type magnetic detecting element is provided on a trailing-side end of a floating slider that is installed in a hard disk device, and serves to detect a recording magnetic field of a hard disk or the like. In addition, in the drawings described below, an X direction corresponds to a track width direction, a Y direction corresponds to a direction of a leakage magnetic field from a magnetic recording medium (heightwise direction), a Z direction corresponds to a moving direction of the magnetic recording medium, such as a hard disk or the like, and a laminated direction of the respective layers of the tunnel-type magnetic detecting element, and an X-Z plane corresponds to a surface of a direction parallel to the recording medium facing surface.

Reference numeral 20 indicates a lower shield layer. The lower shield layer 20 is made of a magnetic material, such as, for example, a NiFe alloy or the like.

A top surface 20a of the lower shield layer 20 corresponds to a surface that forms the tunnel-type magnetic detecting element 21. On the top surface 20a, a laminator 22 is formed which forms the tunnel-type magnetic detecting element 21.

A lowermost layer of the laminator 22 corresponds to a seed layer 23. The seed layer 23 is formed of NiFeCr or Cr. If the seed layer 23 is formed of NiFeCr, the seed layer 23 has a face-centered cubic (fcc) structure in which equivalent crystal planes represented by {111} surfaces are preferentially oriented in a direction parallel to the film surface. If the seed layer 23 is formed of Cr, the seed layer 23 has a body-centered cubic (bcc) structure in which equivalent crystal planes represented by {110} surfaces are preferentially oriented in a direction parallel to a film surface. In addition, a base layer (not shown) may be formed below the seed layer 23. The base layer is formed of a non-magnetic material that contains at least one element selected from the group consisting of Ta, Hf, Nb, Zr, Ti, Mo, and W.

An antiferromagnetic layer 24 is formed on the seed layer 23. The antiferromagnetic layer 24 is preferably formed of an X—Mn alloy, (in this case, X represents at least one element selected from the group consisting of Pt, Pd, Ir, Rh, Ru, and Os). In addition, in the present embodiment, the antiferromagnetic layer 24 may be formed of an X—Mn—X′ alloy, (in this case, the element X′ is at least one element selected from a group consisting of Ne, Ar, Kr, Xe, Be, B, C, N, Mg, Al, Si, PT, V, Cr, Fe, Co, Ni, Cu, Zn, Ga, Ge, Zr, Nb, Mo, Ag, Cd, Sn, Hf, Xa, W, Re, Au, Pb, and rare earth elements).

A fixed magnetic layer 31 is formed on the antiferromagnetic layer 24. The fixed magnetic layer 31 is formed of a magnetic material, such as, for example, a CoFe alloy, a NiFe alloy, Co, a CoNeNi alloy, or the like. A structure of the fixed magnetic layer 31 may be any one of a single-layered structure, a structure in which a plurality of magnetic layers are laminated, a laminated ferrimagnetic structure in which non-magnetic layers are interposed among magnetic layers, or the like. That is, the structure of the fixed magnetic layer 31 is not limited to a specific structure.

By performing a heat treatment, an exchange coupling magnetic field can be generated between the fixed magnetic layer 31 and the antiferromagnetic layer 24, and the magnetization of the fixed magnetic layer 31 can be fixed in a heightwise direction (Y direction in the drawing).

An insulating barrier layer 27 is formed on the fixed magnetic layer 31. The insulating barrier layer 27 is formed of a material, such as Al₂O₃, TiOₓ, MgOₓ, Ti₂O₅, TiO₂, or the like.

A free magnetic layer 28 is formed on the insulating barrier layer 27. The free magnetic layer 28 is formed of a magnetic material, such as a NiFe alloy, a CoFeNi alloy, a CoFe alloy, or the like. For example, the free magnetic layer 28 is preferably formed of a NiFe alloy, and between the free magnetic layer 28 and the insulating barrier layer 27, a dispersion preventing layer is formed which is made of Co or a CoFe alloy. A structure of the free magnetic layer may be any one of a single-layered structure, a structure in which a plurality of magnetic layers are laminated, a laminated ferrimagnetic structure in which non-magnetic layers are interposed among magnetic layers, or the like. That is, the structure of the free magnetic layer 28 is not limited to a specific structure.

An intermediate layer 35 is formed on the free magnetic layer 28, and a corrosion preventing layer 36 is formed on the intermediate layer 35. The intermediate layer 35 is provide so as to further suppress a magnetic characteristic of the free magnetic layer 28 from being deteriorated, as compared with a case in which the corrosion preventing layer 36 is directly formed on the free magnetic layer 28. In this case, the deterioration of the magnetic characteristic means that a magneto-resistance change ratio is deteriorated. As such, if the magnetic characteristic is deteriorated, magnetization stability of the free magnetic layer 28 is lowered, which results in lowering reproduction output. As shown in FIG. 1, the intermediate layer 35 is interposed between the free magnetic layer 28 and the corrosion preventing layer 36, so that it is possible to adequately suppress the magnetic characteristic of the free magnetic layer 28 from being deteriorated. The intermediate layer 35 is preferably formed of a non-magnetic material. In particular, the intermediate layer 35 is formed of a non-magnetic conductive material. If the intermediate layer 35 is formed of an insulating material, current does not sufficiently flow through the intermediate layer 35, which causes the reproduction output of the CPP-type magnetic detecting element to be deteriorated. In addition, it is not preferable that the intermediate layer 35 be formed of a magnetic material, because of the following reason. That is, the intermediate layer 35 also behaves as if it is the free magnetic layer 28, which causes the magnetic characteristic of the free magnetic layer 28 to be deteriorated.

The intermediate layer 35 is preferably formed of a material containing at least one selected from the group consisting of Ta, Ru, Cu, W, and Rh. The intermediate layer 35 may be either a single-layered structure or a multiple-layered structure. In this way, it is possible to adequately suppress the magnetic characteristic of the free magnetic layer 28 from being deteriorated.

The corrosion preventing layer 36 is formed on the intermediate layer 35 such that it can protect the free magnetic layer 28 from reactive ion etching (RIE) and prevent the free magnetic layer 28 from corroding. The reactive ion etching method is an etching method that is used when forming a metallic mask layer (a mask layer for forming a laminator) provided on the corrosion preventing layer 36 in a predetermined shape. The corrosion preventing layer 36, which is against the reactive ion etching, is provided above the free magnetic layer 28, which results in preventing the free magnetic layer 28 from corroding due to the reactive ion etching.

In addition, the corrosion preventing layer 36 is preferably formed of a non-magnetic material. If the corrosion preventing layer 36 is formed of an insulating material, current does not sufficiently flow through the corrosion preventing layer 36, which causes the reproduction output of the CPP-type magnetic detecting element to be deteriorated. In addition, it is not preferable that the corrosion preventing layer 36 be formed of a magnetic material. That is, if the corrosion preventing layer 36 is formed of a magnetic material, the corrosion preventing layer 36 also behaves as if it is a portion of the free magnetic layer 28, which has a large influence on a tunnel magnetoresistance effect. However, in this case, in the same manner as illustrated in the related art, fluoride is introduced on the top surface of the corrosion preventing layer 36 that behaves as if it is a portion of the free magnetic layer and the free magnetic layer corrodes due to the reactive ion etching in appearance, which results in lowering the reproduction characteristic of the magnetic detecting element. The corrosion preventing layer 36 is preferably formed of a material containing at least one selected from the group consisting of Cr, Pt, Ir, Ru, Rh, Pd, and Ag.

The intermediate layer 35 and the corrosion preventing layer 36 are formed on the free magnetic layer 28, thereby forming a free magnetic layer 28 having stable magnetization.

A metallic mask layer 37 is formed on the corrosion preventing layer 36. The metallic mask layer 37 is provided so as to form a sectional shape of the laminator 22 in a substantially trapezoidal shape shown in FIG. 1. The metallic mask layer 37 is formed of a material, which is difficult to be cut by the ion milling. Therefore, at the time of a process in which the laminator 22 is allowed to have a predetermined shape by cutting the laminator 22, the metallic mask layer is slightly cut by the ion milling, but a part of the metallic mask layer remains on the corrosion preventing layer 36 as the metallic mask layer 37 shown in FIG. 1. At this time, the metallic mask layer 37 may not remain on the corrosion preventing layer 36. However, it is preferable that the metallic mask layer 37 remain on the corrosion preventing layer 36. The reason why the metallic mask layer 37 remains on the corrosion preventing layer 36 is because the corrosion preventing layer 36 is formed of a material which is likely to be cut by the ion milling. That is, if all of the metallic mask layer 37 is removed by the ion milling, the corrosion preventing layer right below the metallic mask layer 37 may be cut due to the influence of the ion milling. However, the free magnetic layer 28 may be cut due to the influence of the ion milling. Preferably, the metallic mask layer 37 is formed of a material which contains at least one element selected from the group consisting of Ta, Mo, W, and Ti.

The metallic mask layer 37 is formed of a metallic material. All of the above-mentioned materials corresponds to metallic materials. In addition, the metallic mask layer 37 may be formed of a ‘conductive material’ other than ‘conductive materials’ that are a broader concept than the ‘metal’ in the specification. The ‘conductive material’ refers to a material that represents metallic conductivity. The ‘conductive material’ is a broader concept than ‘metal’. In addition, in the ‘conductive material’, a non-metallic element may be contained.

Further, the laminator 22 shown in FIG. 1 is formed of a laminated structure from the seed layer 23 to the metallic mask layer 37.

As shown in FIG. 1, lateral side ends 22a and 22a of the laminator 22 in a track width direction (X direction in the drawing) are inclined, and the width of the laminator 22 in the track width direction is gradually reduced upward (Z direction in the drawing). An insulating base layer 25 is formed over a region ranging from the top surfaces of the lateral end faces 22a of the laminator 22 to the top surface 20a of the lower shield layer 20 that extends toward both sides of the laminator 22 in the track width direction (X direction in the drawing).

A bias base layer 40 is formed on the insulating base layer 25 that is formed on the lower shield layer 20. The bias base layer 40 is formed of, for example, Cr, CrTi, Ta/CrTi, or the like. The bias base layer 40 is provided so as to improve a characteristic of the hard bias layer 41 (coercive force Hc or remanence ratio).

The hard bias layer 41 is formed on the insulating base layer 25 and the bias base layer 40. The hard bias layer 41 is formed of a CoPt alloy or a CoCrPt alloy. A bias magnetic field is applied to the free magnetic layer 28 from the hard bias layer 41. The magnetization of the free magnetic layer 28 is oriented in the track width direction (X direction) by the bias magnetic field.

The top surface 41a of the hard bias layer 41, which is adjacent to the laminator 22, is formed on the same plane as the top surface 22b of the laminator 22. At a location that is spaced apart from the laminator 22 in the track width direction (X direction in the drawing), the top surface 41b of the hard bias layer 41 is disposed at a lower location than the top surface 41a, and forms a planarized surface. In addition, a protective layer 42 is formed on the top surface 41b of the hard bias layer 41, and the top surface 42a of the protective layer 42 is on the same plane as the top surface 41a of the hard bias layer 41. The protective layer 42 is formed of, for example, Ta or the like.

An upper shield layer 30 is formed on the top surface 22b of the laminator 22, the top surface 41a of the hard bias layer 41, and the top surface 42a of the protective layer 42. The upper shield layer 30 is formed of a magnetic material, such as, for example, NiFe or the like.

In the tunnel-type magnetic detecting element shown in FIG. 1, each of the lower shield layer 20 and the upper shield layer 30 serves as an electrode. The current flows from the lower shield layer 20 and the upper shield layer 30 to the laminator 22 in a direction parallel to a Z direction (that is, a direction vertical to a wall surface of each layer of the laminator 22). The size of the current, which passes through the laminator 22, becomes different, depending on the relationship between the fixed magnetic layer 31 and the free magnetic layer 28 in a magnetization direction.

If an external magnetic field is applied to the tunnel-type magnetic detecting element in a Y direction in the drawing, the magnetization of the free magnetic layer 28 is varied due to the influence of the external magnetic field. As a result, the size of the tunnel current is varied, and the variation amount of the current is used as the variation amount in electrical resistance. In addition, an external magnetic field is detected from the recording medium in a state in which the variation of the electrical resistance is used as the variation of the voltage.

Next, the characteristics according to the present embodiment will be described. In the present embodiment, an intermediate layer 35 is formed on the free magnetic layer 28, and a corrosion preventing layer 36 is formed on the intermediate layer 35. The corrosion preventing layer 36 is provided so as to prevent the free magnetic layer 28 from corroding due to the influence of the reactive ion etching (RIE). Therefore, in the process for forming the laminator 22, when the reactive ion etching is used, it is possible to properly control a disadvantage in that the free magnetic layer 28 corrodes.

In addition, the intermediate layer 35 is made of Ta or the like. The intermediate layer 35 is provided for preventing the corrosion preventing layer 36 made of Cr or the like from coming into contact with the top surface of the free magnetic layer 28 so as to maintain an excellent magnetic characteristic of the free magnetic layer 28. Actually, the intermediate layer 35 is provided, and it is possible to determinate whether the electrical deterioration of the free magnetic layer 28 is alleviated or not. Specifically, the determination whether the electrical deterioration of the free magnetic layer 28 is alleviated or not can be made as follows. That is, a magnetic detecting element where the intermediate layer 35 is formed and a magnetic detecting element where the intermediate layer 35 is not formed (in this case, the two magnetic detecting elements are the same as each other, except for whether the intermediate layer 35 is provided or not), and the reproduction output of each of the two magnetic detecting elements is measured. In this way, it is possible to determinate whether the electrical deterioration of the free magnetic layer 28 is alleviated or not. The large reproduction output can be obtained in the magnetic detecting element where the intermediate layer 35 is formed rather than the magnetic detecting element where the intermediate layer 35 is not formed.

In addition, in the present embodiment, in the process for forming the laminator 22, the metallic mask layer 37 is used, and the liftoff resist layer is not used, as in the related art. Therefore, when the hard bias layer 41 is formed, a phenomenon that the thickness of the hard bias layer 41 decreases in the vicinity of the laminator 22 can be suppressed, and the hard bias layer 41 can be formed at a predetermined thickness. As shown in FIG. 1, the thickness of the hard bias layer 41 becomes largest at the vicinity of the laminator 22, which results in supplying a predetermined bias magnetic field to the free magnetic layer 28.

In the present embodiment, the tunnel-type magnetic detecting element has been embodied, but a CPP (Current Perpendicular to Plane)-GMR (Giant Magneto Resistive) element may be embodied in which the insulating barrier layer 27 is formed of, for example, a non-magnetic conductive layer using Cu or the like and which uses a large magnetoresistance effect.

That is, the present embodiment may be effectively achieved in the CPP-type magnetic detecting element. In the CIP-type magnetic detecting element, the current is divided into the intermediate layer 35, the corrosion preventing layer 36, and the metallic mask layer 37, which results in excessively lowering the reproduction output. In particular, as compared with the related art illustrated in FIG. 7, in the structure of FIG. 1, the intermediate layer 35 and the corrosion preventing layer 36 are further provided, which results in further increasing an amount of divided current. Accordingly, if the laminator 22 shown in FIG. 1 is used in the CIP-type magnetic detecting element, the reproduction output is further output. It is not preferable in this point.

In addition, in the embodiment illustrated in FIG. 1, the intermediate layer 35 and the corrosion preventing layer 36 are formed on the free magnetic layer 28 such that they overlap each other on the corrosion preventing layer 36. The structure in which the corrosion preventing layer 36 is directly formed on the free magnetic layer 28 is the same as the structure illustrated in FIG. 1 in an effect that the free magnetic layer 28 can be protected from the reactive ion etching. Therefore, the above-mentioned structure also corresponds to an example of the present embodiment.

Alternatively, the metallic mask layer 37 may not be provided on the corrosion preventing layer 36.

In addition, it is essential to provide at least the fixed magnetic layer 31, the insulating barrier layer 27, the free magnetic layer 28, and the corrosion preventing layer 36 in forming the laminator 22 according to the present embodiment. Therefore, for example, the antiferromagnetic layer 24 may not be provided.

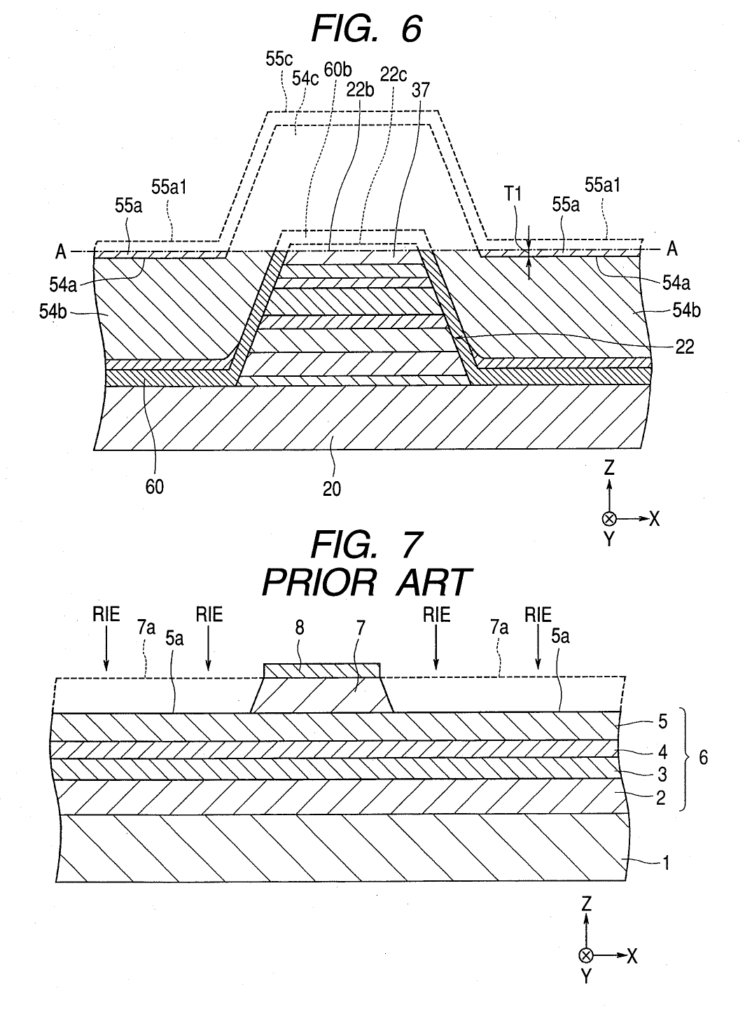

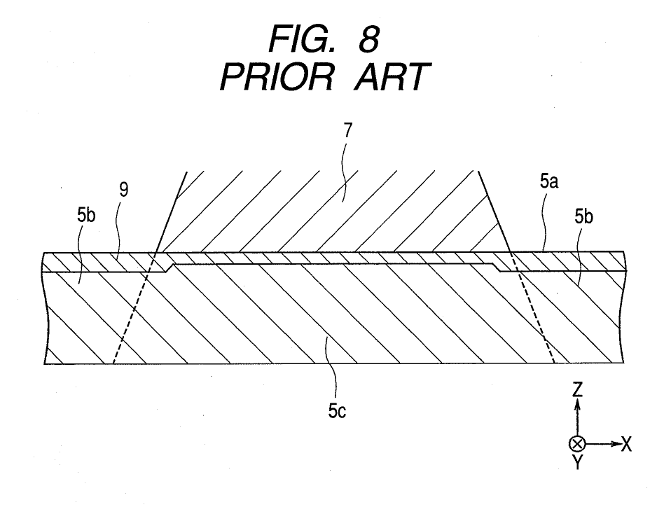

A method of manufacturing the tunnel-type magnetic detecting element shown in FIG. 1 will be described with reference to the accompanying drawings. The respective processes for forming the tunnel-type magnetic detecting element are shown in FIGS. 2 and 6. FIGS. 2 to 6 are partial cross-sectional views illustrating a state in which the tunnel-type magnetic detecting element during the manufacturing process is cut in a direction parallel to the recording medium facing surface.

In the process illustrated in FIG. 2, the laminator 52 is formed on the lower shield layer 20. This laminator 52 has a structure in which a seed layer 23, an antiferromagnetic layer 24, a fixed magnetic layer 31, an insulating barrier layer 27, a free magnetic layer 28, an intermediate layer 35, a corrosion preventing layer 36, and a metallic mask layer 53 are laminated in order from the bottom. Materials of the respective layers are the same as illustrated in FIG. 1. In FIG. 2, reference numeral 53 indicates the metallic mask layer, which is different in FIG. 1 where reference numeral 37 indicates the metallic mask layer. However, this is simply for convenience of description, and the metallic mask layer in FIG. 1 has the same material as the metallic mask layer in FIG. 2. The intermediate layer 35 is formed with the thickness of about 10 to 60 Å. The corrosion preventing layer 36 is formed with the thickness of about 30 to 70 Å. The metallic mask layer 53 is formed with the thickness of about 400 to 800 Å. As shown in FIG. 2, the metallic mask layer 53 is formed such that its thickness is smaller than those of the corrosion preventing layer 36 and the intermediate layer 35. As an example, the thickness of each of the corrosion preventing layer 36 and the intermediate layer 35 is set to 50 Å, and the thickness of the metallic mask layer 53 is set to 500 Å.

As shown in FIG. 2, the mask layer 50 with respect to the metallic mask layer 53 is formed on the metallic mask layer 53. The mask layer 50 needs to be formed of a material which is difficult to be cut by the reactive ion etching (RIE). Preferably, the mask layer 50 is formed of a material which contains at least one element selected from the group consisting of Cr, Pt, Ir, Ru, Rh, Pd, and Ag. First, the mask layer 50 is formed on an entire surface of the metallic mask layer 53 by means of a sputtering method. Then, the resist layer 51 is formed on the mask layer 50 by means of an exposure phenomenon so as to have a predetermined shape. Then, a portion of the mask layer 50, which is not covered with the resist layer 51, is removed by means of ion milling (a portion of the mask layer 50a shown by a dotted line in FIG. 2 is removed).

If an unnecessary mask layer 50a is removed in the mask layer 50, the removed portion is exposed to the top surface 53a of the metallic mask layer 53. The metallic mask layer 53 is likely to be cut by the reactive ion etching (RIE), but it is difficult for the metallic mask layer 53 to be cut by the ion milling. That is, milling speed with respect to the reactive ion etching in the metallic mask layer 53 is slower than that in the mask layer 50. However, the etching speed of reactive ion etching in the metallic mask layer 53 is faster than that in the mask layer 50. Therefore, even though the unnecessary mask layer 50a is removed by the ion milling and the top surface 53a of the metallic mask layer 53 is exposed, it is difficult for the metallic mask layer 53 to be cut by the ion milling, different from the mask layer 50a.

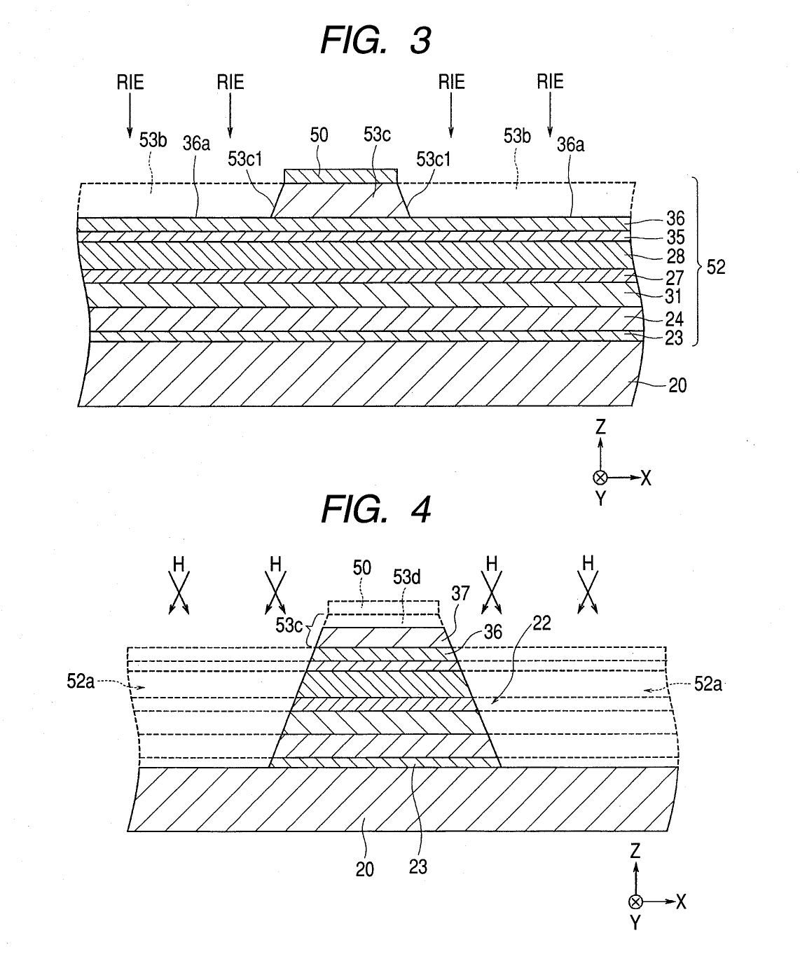

After the resist layer 51 is removed, in the process illustrated in FIG. 3, the unnecessary metallic mask layer 53b of the metallic mask layer 53, which is not covered with the mask layer 50, is removed by means of the reactive ion etching (RIE). As described above, since the etching speed of the reactive ion etching in the mask layer 50 is slower than that of the metallic mask layer 53, the mask layer 50 is not cut by means of the reactive ion etching, and functions as a mask when the metallic mask layer 53 is cut by means of the reactive ion etching.

As shown in FIG. 3, the metallic mask layer 53 remains as a metallic mask layer 53c only below the mask layer 50 by means of the reactive ion etching. Both lateral end faces 53c1 of the metallic mask layer 53c in the track width direction (X direction in the drawing) are inclined, and the width of the metallic mask layer 53c in the track width direction (X direction in the drawing) is gradually decreased in an upward direction.

The top surface 36a of the corrosion preventing layer 36 is exposed to a portion where the unnecessary metallic mask layer 53b is removed by means of the reactive ion etching. A material for forming the corrosion preventing layer 36 is selected such that the etching speed of the reactive ion etching in the corrosion preventing layer 36 is slower than that in the metallic mask layer 53.

For example, when Ta is used in the metallic mask layer 53, if Cr is used in the corrosion preventing layer 36, the etching speed of the reactive ion etching in the metallic mask layer 53 is faster than that in the corrosion preventing layer 36.

Accordingly, even though the top surface 36a of the corrosion preventing layer 36 is exposed by means of the reactive ion etching, the corrosion preventing layer 36 is not cut by means of the reactive ion etching.

Further, if the corrosion preventing layer 36 is provided, the following effects can be achieved. That is, the free magnetic layer 28 is not affected by the reactive ion etching, and it is possible to prevent the free magnetic layer 28 from corroding due to a mixed gas between C₃F₈ and Ar or a CF₄ gas that is used in the reactive ion etching process.

Even in a case in which fluoride is introduced on the top surface 36a of the corrosion preventing layer 36, which is exposed to the outside, by means of the reactive ion etching, if the fluoride is cleaned by using pure water, the fluoride can be removed.

In the process illustrated in FIG. 4, the laminator 52a from the seed layer 23 to the corrosion preventing layer 36, which is not covered with the metallic mask layer 53c, is removed by means of the ion milling. As described above, since the fluoride introduced on the top surface 36a of the corrosion preventing layer 36 is removed by using pure water or the like, the laminator 52a can be removed properly and easily by means of the ion milling process. Each of the arrows shown in FIG. 4 indicates a direction where ion milling is performed. The laminator 53a is removed by means of the ion milling, and the mask layer 50 formed on the metallic mask layer 53c is also removed by means of the ion milling process. If the mask layer 50 is removed, the metallic mask layer 53c is exposed to the outside. The milling speed with respect to the ion milling in the metallic mask layer 53c is slower than that in the corrosion preventing layer 37 or the mask layer 50. However, if the thickness of the portion of the laminator 53a becomes large and the time taken for performing the ion milling process is increased, the metallic mask layer 53c is also slightly affected by the ion milling process. As a result, a portion of the metallic mask layer 53d is removed. Finally, the remaining metallic mask layer 37 has a smaller thickness than the metallic mask layer 53c.

As described above, the metallic mask layer 53c is formed with a smaller thickness than the corrosion preventing layer 36, the intermediate layer 53, or the like. Therefore, even though the metallic mask layer 53c is slightly cut by means of the ion milling process, the metallic mask layer 53c properly remains until all of the unnecessary laminator 52a is removed.

As shown in FIG. 4, when the ion milling process is completed, the laminator 22, in which the respective layers from the seed layer 23 to the metallic mask layer 37 are laminated, remains on the lower shield layer 20. As shown in FIG. 4, a sectional shape of the laminator 22 in a surface direction parallel to the recording medium facing surface (a plane parallel to an X-Y plane in the drawing) becomes a substantially trapezoidal shape.

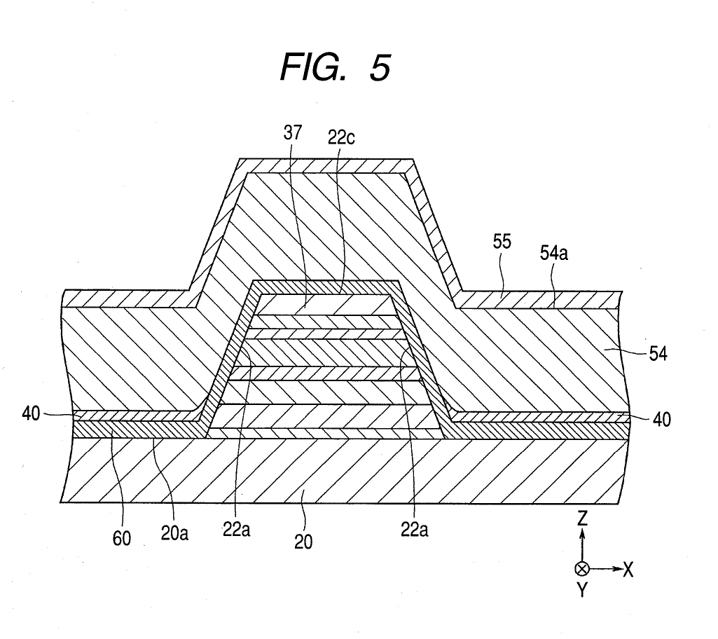

Next, in the process illustrated in FIG. 5, the base material layer 60 is formed on the top surface 20a of the lower shield layer 20, the lateral end faces 22a and 22a of the laminator 22 in the track width direction (X direction in the drawing), and the top surface 22c of the laminator 22 by using a sputtering process by means of, for example, an IBD (Ion Beam Deposition) method or the like. In this case, in the insulating base material layer 60, a portion remains as an insulating base layer 25. For example, the insulating base material layer 60 is preferably formed of a single-layered structure or a multi-layered structure that contains at least one element selected from the group consisting of Si₃N₄, WO, and Al₂O₃.

Then, a bias base layer 40 is formed on the insulating base material layer 60 that is formed on the lower shield layer 20. At this time, the bias base layer 40 is formed of, for example, Cr, CrTi, Ta/CrTi, or the like.

Then, the hard bias material layer 54 is formed on the insulating base material layer 60 and the bias base layer 40 by means of the IBD method or the like. In the hard bias material layer 54, a portion remains as the hard bias layer 41. The hard bias material layer 54 is formed of a CoPt alloy or a CoCrPt alloy. At this time, the hard bias material layer 54 is preferably formed in such a manner that the top surface 54a (the top surface 54a corresponds to the top surface 41b of the hard bias layer 41), which is formed on the hard bias base layer 40, is located below at least the top surface 22c of the laminator 22.

Then, the stopper layer 55 is formed on the hard bias material layer 54. In the stopper layer 55, a portion remains as a protective layer 42 shown in FIG. 1. The stopper layer 55 is preferably formed of a material whose milling speed is slower than that of the hard bias material layer 54. The stopper layer 55 is formed of a material which contains any one of, for example, Ta, Ti, and Mo.

Then, in the process illustrated in FIG. 6, any unnecessary layers, which exist on the top surface 22c of the laminator 22, are removed (portions by dotted lines in FIG. 6). In this case, ‘the unnecessary layers’ correspond to the insulating base material layer 60b, the hard bias material layer 54c, and the stopper layer 55c, which are shown by dotted lines in FIG. 6. These unnecessary layers are removed by means of, for example, a CMP process.

As shown in FIG. 6, the above-mentioned layers cut up to the line VI-VI. As shown in FIG. 6, on the line VI-VI, the stopper layer 55a exists which is formed on the top surface 54a of the hard bias material layer 54 that is located at both sides of the laminator 22 in the track width direction (X direction in the drawing). A portion of the stopper layer 55a is also cut by means of the CMP process. For example, it is preferable that the time when the cutting process is completed by means of the CMP process is controlled on the basis of the thickness T1 of the remaining film of the stopper layer 55a.

As shown in FIG. 6, the top surface 54a of the hard bias material layer 54, which is formed on the bias base layer 35, formed on at least a lower location than the top surface 22c (top surface of the metallic mask layer 37) of the laminator 22 before performing the CMP process. In addition, the top surface 55a1 of the stopper layer 55a, which is formed on the top surface 54a of the hard bias material layer 54, is formed on a higher location than the top surface 22c of the laminator 22. As a result, while all of the unnecessary layers, which is formed on the top surface 22c of the laminator 22, is cut by means of the CMP process, the time when the stopper layer 55a is also necessarily removed exists.

The top surface of the stopper layer 55a is also cut, which results in rapidly reducing the polishing speed. As a result, it can be confirmed that the cutting process through the CMP process is almost completed. If the time when the cutting process through the CMP process is completed is controlled on the basis of the thickness T1 of the remaining film of the stopper layer 55a, the CMP process is completed at a predetermined location. Even if a portion or all of the metallic mask layer 37, which forms an uppermost layer of the laminator 22, is cut, a problem does not occur. That is, at the time when the cutting process is completed, the top surface 22b of the laminator 22 (the same location as the top surface 22b of the laminator 22 shown in FIG. 1) may be formed at a lower location than the top surface 22c before performing the cutting process. The ‘unnecessary layers’ are removed by means of the unnecessary process through the CMP process, and thus the exposed top surface 22b of the laminator 22 becomes the top surface b of the laminator 22 shown in FIG. 1.

The insulating base material layer 60a, which remains at the time when the cutting process is completed, is the same as the insulating base layer 25 shown in FIG. 1, and the hard bias material layer 54b shown in FIG. 6 is the same as the hard bias layer 41 shown in FIG. 1.

When all of the stopper layer 55a is not cut by means of the CMP process, the stopper layer 55a remains as the protective layer 42 shown in FIG. 1. In addition, it may be constructed such that the stopper layer 55a does not remain as the protective layer 42 by properly controlling a location at which the stopper layer 55a is formed and completing the CMP process when all of the stopper layer 55a is cut. However, it is preferable that the top surface 54a of the hard bias material layer 54, which remains as the hard bias layer 41 below the stopper layer 55a, not be cut by means of the CMP process. Therefore, it is preferable that a portion of the stopper layer 55a whose polishing speed is slow remains as the protective layer 42 on the hard bias layer 41, as shown in FIG. 1, in that the hard bias layer 41 having the predetermined thickness can be properly and easily disposed at both sides of the laminator 22 in the track width direction (X direction in the drawing).

In a method of manufacturing the tunnel-type magnetic detecting element according to the present embodiment that is shown in FIGS. 2 to 6, in the process illustrated in FIG. 2, the intermediate layer 35, the corrosion preventing layer 36, the metallic mask layer 53, and the mask layer 50 are sequentially laminated on the free magnetic layer 28, and the mask layer 53 is formed in a predetermined shape by using the mask layer 50 and the reactive ion etching (RIE). In this case, as shown in FIG. 3, since the corrosion preventing layer 36 is exposed to the surface where the metallic mask layer 53 is cut, the free magnetic layer 28 is not affected by the reactive ion etching. Accordingly, it is possible to properly prevent the free magnetic layer from corroding, as compared with the related art. Since the etching speed of the reactive ion etching in the corrosion preventing layer 36 becomes much slower than that in the metallic mask layer 53, all of the corrosion preventing layer 36 is not cut by means of the reactive ion etching. As a result, the corrosion preventing layer 36 properly remains on the free magnetic layer 28, and thus functions as a protective layer that protects the free magnetic layer 28 from the reactive ion etching.

Even though the fluoride is temporarily introduced on the top surface 36a of the corrosion preventing layer 36, it is cleaned by pure water, the fluoride can be removed. Therefore, a failure does not occur when the corrosion preventing layer 36 is subjected to the ion milling process illustrated in FIG. 4. In addition, the corrosion preventing layer 36 is slower than the metallic mask layer 53 in a milling speed at the time of the ion milling process, and the unnecessary portions of the corrosion preventing layer 36 can be removed by using the metallic mask layer by means of the ion milling process.

In addition, as shown in FIG. 2, the intermediate layer 35, which is capable of suppressing the deterioration of the magnetic characteristic of the free magnetic layer 28, is preferably formed between the free magnetic layer 28 and the corrosion preventing layer 36, as compared with a case in which the corrosion preventing layer 36 is formed directly on the free magnetic layer 28. In this way, it is possible to suppress the magnetic deterioration of the free magnetic layer 28 (specifically, the lowering of a magneto-resistance change ratio). As a result, it is possible to improve the stability of the magnetization of the free magnetic layer 28, which results in improving the reproduction output.

In addition, the forming of the stopper layer 55, which is formed on the hard bias material layer 54 in the process illustrated in FIG. 5, is not essential. However, the forming of the stopper layer 55 is more preferable in that the time when the cutting process is completed can easily be controlled by the CMP process shown in FIG. 6, for example, excessive cutting of the top surface of the laminator 22 or the top surface of the hard bias layer 36 can be controlled.

In addition, in the present embodiment, the liftoff resist layer is not used, as in the related art. Therefore, at the time of forming the insulating base layer 60 or the hard bias material layer 54, a shadow effect occurring when the resist layer is used is not generated. Therefore, it is possible to allow the thickness of the insulating material layer 60 formed at both sides of the laminator 22 in the track width direction to be limited to the predetermined thickness. In addition, the variation of the hard bias material layer 54 in the thickness can also be decreased. In particular, the finally remaining hard bias layer 41 (see FIG. 1) in the vicinity of both sides of the laminator 22 can be formed with a large thickness, and a sufficient bias magnetic field can be applied to the free magnetic layer 28.

According to the aspects of the invention, the corrosion preventing layer against the reactive ion etching is directly or indirectly formed on the free magnetic layer. Therefore, the free magnetic layer can be properly prevented from corroding due to the reactive ion etching, which results in manufacturing a magnetic detecting element having an excellent reproduction characteristic.

1. A magnetic detecting element comprising:
at least a fixed magnetic layer, a non-magnetic material layer, and a free magnetic layer which are laminated on a substrate,
a corrosion preventing layer against reactive ion etching which is directly or indirectly formed on the free magnetic layer.

2. The magnetic detecting element according to claim 1,
wherein the corrosion preventing layer is formed of at least one element selected from the group consisting of Cr, Pt, Ir, Ru, Rh, Pd, and Ag.

3. The magnetic detecting element according to claim 1,
wherein an intermediate layer is formed between the free magnetic layer and the corrosion preventing layer so as to suppress deterioration of a magnetic characteristic of the free magnetic layer, as compared with a case in which the corrosion preventing layer is directly formed on the free magnetic layer.

4. The magnetic detecting element according to claim 3,
wherein the intermediate layer is formed of at least one element selected from the group consisting of Ta, Ru, Cu, W, and Rh.

5. The magnetic detecting element according to claim 1,
wherein the magnetic detecting element is a tunnel-type magnetic detecting element in which the non-magnetic material layer is formed of an insulating barrier layer.

6. A method of manufacturing a magnetic detecting element, comprising the steps of:
(a) laminating on a substrate at least a fixed magnetic layer, a non-magnetic material layer, and a free magnetic layer in this order from the bottom while forming a corrosion preventing layer against reactive ion etching directly or indirectly on the free magnetic layer,
(b) forming on the corrosion preventing layer the laminator forming mask layer having a predetermined shape by means of the reactive ion etching, the reactive ion etching being completed around the laminator forming mask layer when a surface of the corrosion preventing layer is exposed to the outside; and
(c) removing the fixed magnetic layer, the non-magnetic material layer, the free magnetic layer, and the corrosion preventing layer, which are not covered with the laminator forming mask layer,
wherein in the step of (a), the corrosion preventing layer is formed of a material of which the etching speed of the reactive ion etching is slower than the etching speed of the reactive ion etching of a material of the laminator forming mask layer formed in the step of (b);

7. The method of manufacturing a magnetic detecting element according to claim 6,
wherein the corrosion preventing layer is formed of at least one element selected from the group consisting of Cr, Pt, Ir, Ru, Rh, Pd, and Ag.

8. The method of manufacturing a magnetic detecting element according to claim 6,
wherein the laminator forming mask layer is formed of at least one element selected from the group consisting of Ta, Mo, W, and Ti.

9. The method of manufacturing a magnetic detecting element according to claim 6,
wherein in the step of (a), an intermediate layer is formed between the free magnetic layer and the corrosion preventing layer so as to suppress deterioration of a magnetic characteristic of the free magnetic layer, as compared with a case in which the corrosion preventing layer is directly formed on the free magnetic layer.

10. The method of manufacturing a magnetic detecting element according to claim 9,
wherein the intermediate layer is formed of at least one element selected from the group consisting of Ta, Ru, Cu, W, and Rh.

11. The method of manufacturing a magnetic detecting element according to claim 6, further comprising a step of:
(d) forming bias layers at both sides of the laminator in a track width direction from the fixed magnetic layer to the laminator forming mask layer, which remain on the substrate, after the step of (c), the bias layer applying a bias magnetic field to the free magnetic layer.

12. The method of manufacturing a magnetic detecting element according to claim 11, further comprising the steps of:
after the step of (d),
(e) forming a stopper layer on the bias layer; and
(f) completing a process for removing unnecessary layers formed on a top surface of the laminator, when at least a portion of the stopper layer is removed.

13. The magnetic detecting element according to claim 1, wherein the fixed magnetic layer, non-magnetic layer and free magnetic layer are laminated on a substrate in this order from the bottom.
